(19) United States
(12) Patent Application Publication
(10) Pub. No.: US 2024/0014942 A1
(43) Pub. Date: Jan. 11, 2024

(54) HARQ PROCESS HANDLING UPON CONFIGURED GRANT DEACTIVATION

(71) Applicant: Telefonaktiebolaget LM Ericsson (PUBL), Stockholm (SE)

(72) Inventors: Min WANG, LULEÅ (SE); Antonino Orsino, KIRKKONUMMI (FI)

(21) Appl. No.: 18/249,803

(22) PCT Filed: Oct. 22, 2021
(86) PCT No.: PCT/IB2021/059764

§ 371 Date: Apr. 20, 2023

Related U.S. Application Data
(60) Provisional application No. 63/094,951, filed on Oct. 22, 2020.

(51) Int. Cl. H04L 1/1812; H04L 1/1829; H04W 72/12

(52) U.S. Cl. CPC H04L 1/1812; H04L 1/1835; H04W 72/12

(57) ABSTRACT

According to some embodiments, a method performed by a wireless device for deactivating a sidelink configured grant comprises: receiving an indication to deactivate a sidelink configured grant; and flushing one or more hybrid automatic repeat request (HARQ) buffers of one or more pending HARQ processes containing one or more transport blocks (TBs) that are being transmitted/retransmitted using the configured sidelink grant.

### TECHNICAL FIELD

Embodiments of the present disclosure are directed to wireless communications and, more particularly, to hybrid automatic repeat request (HARQ) process handling upon configured grant (CG) deactivation.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Fifth generation (5G) new radio (NR), similar to long term evolution (LTE), uses orthogonal frequency division multiplexing (OFDM) in the downlink (i.e., from a network node, gNB, eNB, or base station, to a user equipment (UE)). The basic NR physical resource over an antenna port can thus be seen as a time-frequency grid as illustrated in FIG. 1.

FIG. 1 is a time frequency diagram illustrating an NR physical resource grid. FIG. 1 illustrates a resource block (RB) in a 14-symbol slot. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈(0,1,2,3,4). Δf=15 kHz is the basic (or reference) subcarrier spacing that is also used in LTE.

In the time domain, downlink and uplink transmissions in NR may be organized into equally-sized subframes of 1 ms each, similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols.

Downlink transmissions are dynamically scheduled, i.e., in each slot the gNB transmits downlink control information (DCI) about which UE data is to be transmitted to and which resource blocks in the current downlink slot the data is transmitted on. The control information is typically transmitted in the first one or two OFDM symbols in each slot in NR. The control information is carried on the physical downlink control channel (PDCCH) and data is carried on the physical downlink shared channel (PDSCH). A UE first detects and decodes PDCCH and if a PDCCH is decoded successfully, the UE then decodes the corresponding PDSCH based on the downlink assignment provided by decoded control information in the PDCCH.

In addition to PDCCH and PDSCH, there are also other channels and reference signals transmitted in the downlink, including synchronization signal block (SSB), channel state information reference signal (CSI-RS), etc.

Uplink data transmissions, carried on the physical uplink shared channel (PUSCH), can also be dynamically scheduled by the gNB by transmitting a DCI., the DCI (which is transmitted in the downlink region) indicates a scheduling time offset so that the PUSCH is transmitted in a slot in the uplink region.

NR also includes sidelink transmission. Sidelink transmissions over NR are enhancements of the ProSe (PROximity-based SErvices) specified for LTE. NR sidelink transmission includes four new enhancements.

NR sidelink includes support for unicast and groupcast transmissions. For unicast and groupcast, the physical sidelink feedback channel (PSFCH) is used for a receiver UE to send the decoding status to a transmitter UE. NR sidelink includes grant-free transmissions, which are adopted in NR uplink transmissions, to improve the latency performance.

To alleviate resource collisions among different sidelink transmissions launched by different UEs, NR sidelink enhances channel sensing and resource selection procedures, which also leads to a new design of PSCCH. To achieve a high connection density, NR sidelink includes congestion control and QoS management.

To enable the above enhancements, new physical channels and reference signals are included in NR (available in LTE before.):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID is sent on the PSSCH to be decoded by the receiver UE.

Similar as for PRoSE in LTE, NR sidelink transmissions have two modes of resource allocations. In Mode 1, sidelink resources are scheduled by a gNB. In Mode 2, the UE autonomously selects sidelink resources from a (pre-)configured sidelink resource pool(s) based on the channel sensing mechanism. For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2. Mode 1 supports dynamic grant and configured grant. For dynamic grant, when traffic to be sent over sidelink arrives at a transmitter UE, the transmitter UE launches the four-message exchange procedure to request sidelink resources from a gNB (SR on UL, grant, BSR on UL, grant for data on SL sent to UE).

During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with cyclic redundancy check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.

For the traffic with a strict latency requirement, performing the four-message exchange procedure to request sidelink resources may induce unacceptable latency. For this traffic configured grant may be more appropriate. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, the UE can launch the PSCCH and the PSSCH on the upcoming resource occasion. This kind of grant is also referred to as grant-free transmissions.

In both dynamic grant and configured grant, a sidelink receiver UE cannot receive the DCI (because it is addressed to the transmitter UE), and therefore a receiver UE performs blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, the transmitter UE autonomously selects resources for the PSCCH and the PSSCH. To further minimize the latency of the feedback HARQ ACK/NACK transmissions and subsequent retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, the transmitter UE selects resources for the PSSCH associated with the PSCCH for initial transmission and blind retransmissions and the PSSCH associated with the PSCCH for retransmissions.

Because each transmitter UE in sidelink transmissions should autonomously select resources for the above transmissions, preventing different transmitter UEs from selecting the same resources turns out to be a critical issue in Mode 2. A particular resource selection procedure is therefore imposed to Mode 2 based on channel sensing. The channel sensing algorithm involves measuring reference signal received power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

Device-to-device (D2D) discovery procedures are used for detection of services and applications offered by other UEs in close proximity. The discovery procedure has two modes, mode A based on open announcements (broadcasts) and mode B, which is request/response. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

As described in TS 38.321 v 16.2.1 clause 5.8.3, there are two types of transmission without dynamic grant. These are configured grant Type 1 and configured grant Type 2.

Configured grant Type 1 is where a sidelink grant is provided by RRC and stored as a configured sidelink grant. Configured grant Type 2 is where a sidelink grant is provided by PDCCH and stored or cleared as a configured sidelink grant based on L1 signaling indicating configured sidelink grant activation or deactivation.

Type 1 and/or Type 2 are configured with a single BWP. Multiple configurations of up to 8 configured grants (including both Type 1 and Type 2, if configured) can be active simultaneously on the BWP.

RRC configures the following parameters when the configured grant Type 1 is configured, as specified in TS 38.331 or TS 36.331:
sl-ConfiglndexCG: the identifier of a configured grant for sidelink;
sl-CS-RNTI: SLCS-RNTI for retransmission;
sl-NrOfHARQ-Processes: the number of HARQ processes for configured grant;
sl-PeriodCG: periodicity of the configured grant Type 1;
sl-TimeOffsetCG-Type1: Offset of a resource with respect to SFN=sl-TimeReferenceSFN-Type1 in time domain, referring to the number of logical slots that can be used for SL transmission;
sl-TimeResourceCG-Type1: time resource location of the configured grant Type 1;
sl-CG-MaxTransNumList: the maximum number of times that a TB can be transmitted using the configured grant;
sl-HARQ-ProcID-offset: offset of HARQ process for configured grant Type 1;
sl-TimeReferenceSFN-Type1: SFN used for determination of the offset of a resource in time domain. The UE uses the closest SFN with the indicated number preceding the reception of the sidelink configured grant configuration Type 1.
RRC configures the following parameters when the configured grant Type 2 is configured, as specified in TS 38.331:
sl-ConfiglndexCG: the identifier of a configured grant for sidelink;
sl-CS-RNTI: SLCS-RNTI for activation, deactivation, and retransmission;
sl-NrOfHARQ-Processes: the number of HARQ processes for configured grant;
sl-PeriodCG: periodicity of the configured grant Type 2;
sl-CG-MaxTransNumList: the maximum number of times that a TB can be transmitted using the configured grant;
sl-HARQ-ProcID-offset: offset of HARQ process for configured grant Type 2.

Upon configuration of a configured grant Type 1, the MAC entity shall for each configured sidelink grant, store the sidelink grant provided by RRC as a configured sidelink grant and initialize or re-initialize the configured sidelink grant to determine PSCCH duration(s) and PSSCH duration(s) according to sl-TimeOffsetCG-Type1 and sl-TimeResourceCG-Type1, and to reoccur with sl-periodCG for transmissions of multiple MAC PDUs according to clause 8.1.2 of TS 38.214.

If the MAC entity is configured with multiple configured sidelink grants, collision among the configured sidelink grants may occur. How to handle the collision is left to UE implementation.

After a sidelink grant is configured for a configured grant Type 1, the MAC entity shall consider sequentially that the first slot of the S^{th} sidelink grant occurs in the logical slot for which:

[(SFN×numberOfSLSlotsPerFrame)+logical slot number in the frame]=(sl-TimeReferenceSFN-Type1×numberOfSLSlotsPerFrame+sl-TimeOffsetCGType1+S×PeriodicitySL)modulo (1024×numberOfSLSlotsPerFrame).

where

$$PeriodicitySL = ⌈ \frac{N}{20 ms} \times sl \_ periodCG ⌉ ,$$

numberOfSLSlotsPerFrame refers to the number of logical slots that can be used for SL transmission in the frame and N refers to the number of slots that can be used for SL transmission within 20 ms, if configured, of TDD-UL-DL-ConfigCommon, as specified in TS 38.331 and clause 8.1.7 of TS 38.214.

After a sidelink grant is configured for a configured grant Type 2, the MAC entity shall consider sequentially that the first slot of S^{h} sidelink grant occurs in the logical slot for which:

[(SFN×numberOfSLSlotsPerFrame)+logical slot number in the frame]=[(SFN_{start time}×numberOfSLSlotsPerFrame+slot_{start time})+S×PeriodicitySL] modulo (1024×numberOfSLSlotsPerFrame).

where SFN_{start time} and slot_{start time} are the SFN and logical slot, respectively, of the first transmission opportunity of PSSCH where the configured sidelink grant was (re-)initialized.

When a configured sidelink grant is released by RRC, all the corresponding configurations shall be released and all corresponding sidelink grants shall be cleared.

If the configured sidelink grant confirmation has been triggered and not cancelled; and if the MAC entity has UL resources allocated for new transmission, then the MAC entity will instruct the Multiplexing and Assembly procedure to generate a Sidelink Configured Grant Confirmation MAC CE as defined in clause 6.1.3.34 and cancel the triggered configured sidelink grant confirmation.

For a configured grant Type 2, the MAC entity will clear the corresponding configured sidelink grant immediately after first transmission of Sidelink Configured Grant Confirmation MAC CE triggered by the configured sidelink grant deactivation.

There currently exist certain challenges. For example, as described in clause 5.22.1.1 in TS 38.321 v 16.2.1, if a sidelink grant has been received on the PDCCH for the MAC entity's SLCS-RNTI, and if the PDCCH contents indicate configured grant Type 2 deactivation for a configured sidelink grant, then the UE clears the configured sidelink grant, if available, and triggers configured sidelink grant confirmation for the configured sidelink grant.

A problem with the above actions is that the UE may have pending TBs in the HARQ processes containing TBs using the configured SL grant. There may be one or multiple HARQ processes containing the TBs using the configured SL grant that needs to be deactivated. If the corresponding SL grant is cleared, the UE would not be able to perform further retransmissions for these pending TBs using the configured SL grant. In other words, the UE has to wait for dynamic grants scheduled by the gNB for further retransmissions. However, the gNB may not be aware of the pending TBs. In this case, the UE will not get new grants to retransmit the pending TBs.

Thus, a UE is not able to use the pending HARQ processes for new transmissions. This further causes resource wastage. Another problem is long latency to the pending TBs. Eventually, the TBs will be lost if the latency is beyond the packet delay budget. If a gNB assigns a new grant for a HARQ process containing pending TB, the UE would be in a dilemma situation, i.e., flush HARQ buffer and perform new transmission using the HARQ process or retransmit the TB using the grant. However, the grant may also provide a different TBS from the size of the pending TB.

### SUMMARY

Based on the description above, certain challenges currently exist with hybrid automatic repeat request (HARQ) process handling upon configured grant (CG) deactivation. Certain aspects of the present disclosure and their embodiments may provide solutions to these or other challenges. In particular embodiments, if a UE receives a DCI command to deactivate a SL CG configuration, the UE takes at least one of the options below to handle each non-idle HARQ process that contains TBs.

In Option 1, the UE immediately flushes the HARQ buffer of HARQ processes containing TBs which are being transmitted/retransmitted using the configured SL grant.

In Option 2, the UE sends an indication to the gNB indicating that there are pending HARQ processes that need to be scheduled for further retransmissions. After sending the indication, the UE may start a timer. After the timer is expired, if the UE does not receive any dynamic grants for the pending HARQ processes, the UE flushes the HARQ buffer of those HARQ processes.

In Option 3, prior to clearing the SL configured grant, the UE retransmits one or multiple pending TBs for up to a configured number of times.

According to some embodiments, a method performed by a wireless device for deactivating a sidelink configured grant comprises: receiving an indication to deactivate a sidelink configured grant; and flushing one or more HARQ buffers of one or more pending HARQ processes containing one or more TBs that are being transmitted/retransmitted using the configured sidelink grant.

In particular embodiments, the method further comprises, prior to flushing the one or more HARQ buffers, retransmitting one or more of the TBs that are being transmitted/retransmitted using the configured sidelink grant.

In particular embodiments, the method further comprises transmitting an indication to a network node indicating that the wireless device has one or more pending HARQ processes that need to be scheduled for further retransmissions. The indication may include one or more of: a HARQ process index; a transport block size; an identifier of a logical channel; a service or traffic type associated with the one or more TBs; and a remaining packet delay budget for the one or more TBs.

In particular embodiments, the indication comprises a negative HARQ acknowledgment for each of the one or more pending HARQ processes or a scheduling request for each of the one or more pending HARQ processes.

In particular embodiments, the method further comprises starting a timer and prior to flushing the one or more HARQ buffers of the one or more pending HARQ processes, determining that the timer has expired and that the wireless device has not received a dynamic grant for the one or more pending HARQ processes. A duration of the timer may be based on a remaining packet delay budget for the TBs that are being transmitted/retransmitted using the configured sidelink grant.

In particular embodiments, the method further comprises resetting a counter of each of the one or more pending HARQ process for counting number of transmissions of each of the TBs to be zero.

In particular embodiments, the method further comprises setting a new data indicator (NDI) for each of the one or more pending HARQ processes to zero.

In particular embodiments, the indication to deactivate a sidelink configured grant includes one or more HARQ process identifiers and flushing the one or pending HARQ processes comprises flushing the HARQ processes associated with the one or more HARQ process identifiers.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node comprises receiving an indication indicating that a wireless device has one or more pending HARQ processes that need to be scheduled for further retransmissions and transmitting a scheduling grant to the wireless device for the one or more pending HARQ processes.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments include improved configuration flexibility for handling configured resources, improved utilization of configured resources considering service QoS requirements, improved satisfaction of QoS requirements of different services that share the same configured resource, and reduced latency because the UE does not get stuck with TBs in its buffer without knowing what to do with them.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a time frequency diagram illustrating a new radio (NR) physical resource grid;

FIG. 2 is a block diagram illustrating an example wireless network;

FIG. 3 illustrates an example user equipment, according to certain embodiments;

FIG. 4 is flowchart illustrating an example method in a wireless device, according to certain embodiments;

FIG. 5 is flowchart illustrating an example method in a network node, according to certain embodiments;

FIG. 6 illustrates a schematic block diagram of a wireless device and a network node in a wireless network, according to certain embodiments;

FIG. 7 illustrates an example virtualization environment, according to certain embodiments;

FIG. 8 illustrates an example telecommunication network connected via an intermediate network to a host computer, according to certain embodiments;

FIG. 9 illustrates an example host computer communicating via a base station with a user equipment over a partially wireless connection, according to certain embodiments;

FIG. 10 is a flowchart illustrating a method implemented, according to certain embodiments;

FIG. 11 is a flowchart illustrating a method implemented in a communication system, according to certain embodiments;

FIG. 12 is a flowchart illustrating a method implemented in a communication system, according to certain embodiments; and

FIG. 13 is a flowchart illustrating a method implemented in a communication system, according to certain embodiments.

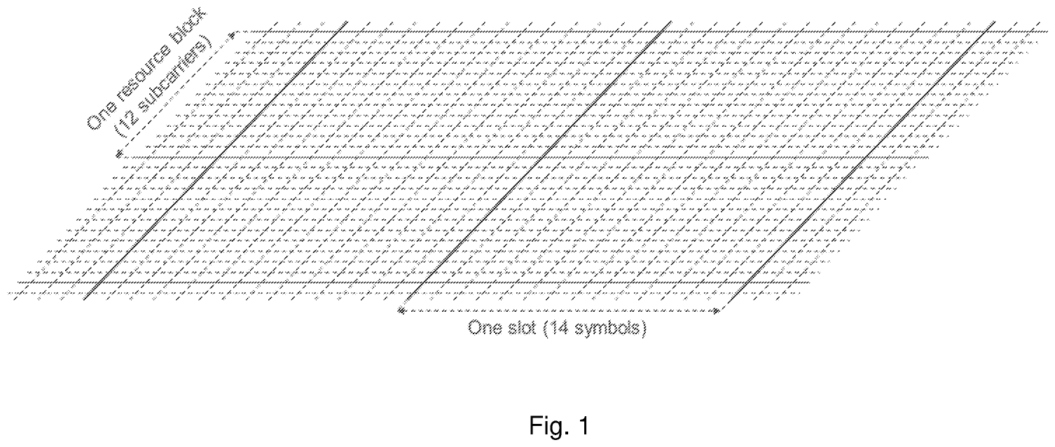

### DETAILED DESCRIPTION

As described above, certain challenges currently exist with hybrid automatic repeat request (HARQ) process handling upon configured grant (CG) deactivation. For example, when a user equipment (UE) is instructed to clear a configured sidelink grant, the UE may have pending transport blocks (TBs) in the hybrid automatic repeat request (HARQ) processes using the configured sidelink grant.

Certain aspects of the present disclosure and their embodiments may provide solutions to these or other challenges. In particular embodiments, if a UE receives a downlink control information (DCI) command to deactivate a sidelink CG configuration, the UE takes at least one of the options below to handle each non-idle HARQ process that contains TBs.

In Option 1, the UE immediately flushes the HARQ buffer of HARQ processes containing TBs which are being transmitted/retransmitted using the configured SL grant.

In Option 2, the UE sends an indication to the gNB indicating that there are pending HARQ processes that need to be scheduled for further retransmissions. After sending the indication, the UE may start a timer. After the timer is expired, if the UE does not receive any dynamic grants for the pending HARQ processes, the UE flushes the HARQ buffer of those HARQ processes.

In Option 3, prior to clearing the SL configured grant, the UE retransmits one or multiple pending TBs for up to a configured number of times.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Although the embodiments herein are described in the context of new radio (NR), i.e., a transmitter UE performs NR sidelink transmission to a receiver UE, the embodiments are also applicable to UEs performing long term evolution (LTE) sidelink transmissions.

In the below embodiments, a non-idle HARQ process is defined as a HARQ process whose associated media access control (MAC) protocol data unit (PDU) has been submitted to lower layers for transmission but for which successful reception acknowledgment has not been received yet from the receiver. A non-idle HARQ process may be also referred as to a pending HARQ process. The below embodiments are not limited by terms. Any similar term is equally applicable.

In particular embodiments, when a UE receives a DCI command to deactivate a SL CG configuration, the UE takes at least one of the options below to handle each non-idle HARQ process that contains TBs.

In Option 1, the UE immediately flushes the HARQ buffer of HARQ processes containing TBs which are being transmitted/retransmitted using the configured SL grant. In Option 2, the UE sends an indication to the gNB indicating that there are pending HARQ processes that need to be scheduled for further retransmissions. After sending the indication, the UE may start a timer. After the timer is expired, if the UE does not receive a dynamic grant for the pending HARQ processes, the UE flushes the HARQ buffer of the HARQ processes.

For Option 1, the TBs which are pending are cleared immediately. The corresponding HARQ processes are released and ready for new transmissions. In addition, the UE may also immediately trigger upper layer retransmissions (e.g., radio link control (RLC) or packet data convergence protocol (PDCP)).

For Option 2, the UE may send the indication to the gNB via at least one of the below signalling alternatives. The UE may use dedicated RRC signalling. For example, the UE may use assistance information or the sidelink UE information procedure to carry such indication. Alternatively, a new RRC signalling message may be defined.

The UE may use a MAC control element (CE). A new MAC CE may be defined accordingly.

The UE may use physical uplink control channel (PUCCH) signalling. The UE may use specific PUCCH resources to send signalling.

The UE may use physical random access channel (PRACH) signalling. The UE may use specific PRACH preambles or PRACH resources (e.g., ROs) to send signalling.

For any of the above signalling alternatives, the signalling may include at least one or more of the following information elements: (a) indices of the HARQ processes containing TBs that are being transmitted or retransmitted using the SL grant that needs to be deactivated corresponding to the received DCI SL CG deactivation command; (b) transport block size (TBS) of the pending TBs; (c) logical channels (LCHs) and/or logical channel groups (LCGs) associated with the pending TBs; (d) services or traffic types associated with the pending TBs; and (e) remaining packet delay budgets of the pending TBs.

For PUCCH signaling, it may be sufficient for the UE to transmit negative HARQ acknowledgement for each pending HARQ process. This will trigger the gNB to schedule new grants for retransmissions. Alternatively, the UE may trigger a scheduling request (SR) for pending TBs.

For Option 2, a new timer may be defined for each non-idle HARQ process. The timer is started after the UE has sent the signaling to the gNB. While the timer is running, the UE does not flush the HARQ buffer of those pending HARQ processes. While the timer is running, if the UE receives a dynamic grant for a pending HARQ process, the UE uses the grant to retransmit the TB. Meanwhile, the timer is stopped. If the time is expired, while the UE has not received any dynamic grant for a pending HARQ process, the UE flushes the HARQ buffer of the pending HARQ process.

The duration/value of the timer may be equal to the remaining packet delay budget (after which the transmission is not valid anymore), or it may be equal to the remaining packet delay budget minus a delta. The delta may be decided by the gNB, preconfigured/hardcoded into the specification or decided autonomously by the UE. In some embodiments, the duration of the timer may be decided by the gNB, decided autonomously by the UE or hardcoded in the specification. The duration of the timer may be linked to a certain packet delay budget, QoS profile, application or service. The mapping between the duration of the timer and the PDB/QoS profile/service/application, may be hardcoded in the specification or decided by the gNB. The value of the timer may be in absolute time units (e.g., ms) or in multiples of the CG periodicity.

In Option 3, prior to clearing the SL configured grant, the UE retransmits one or multiple pending TBs for up to a configured number of times with anticipation that the UE will succeed in transmitting the pending TBs. In some embodiments, the UE performs further retransmissions of the pending TB for a specific HARQ process before clearing the SL configured grant. The specific HARQ process may be configured by RRC or indicated in the CG deactivation command.

For any of the above options, for a UE, which option is applied may be configured by the gNB or a controlling UE via at least one of the below signaling alternatives: (a) RRC signaling; (b) MAC CE; (c) L1 signaling such as DCI on PDCCH, SCI; (D) control PDUs of a protocol layer such as SDAP, PDCP, RLC or adaptation layer (e.g., in a relay scenario).

In some embodiments, the option applied by UE may be captured in a specification in a hard-coded fashion. The option applied by UE may be specified in pre-configuration.

In some embodiments, when a UE receives a DCI command to deactivate a SL CG configuration, the UE resets the counter of each pending HARQ process for counting number of transmissions (including both initial transmission and retransmissions) of each TB to be zero.

In some embodiments, the DCI deactivation command comprises a HARQ process ID field. In this case, the UE may only flush the HARQ buffer of the indicated HARQ process and reset the counter of each pending HARQ process for counting number of transmissions (including both initial transmission and retransmissions) of each TB to be zero.

In some embodiments, the UE performs first Option 1 and then Option 2. This means that the UE, when it receives a DCI command to deactivate a SL CG configuration, first flushes the HARQ buffer of HARQ processes containing TBs which are being transmitted/retransmitted using the configured SL grant. After flushing the HARQ buffers, the UE sends an indication to the gNB for informing that the buffer of certain HARQ processes have been flushed. Thus, the indication to the gNB is for information and not to require new grants to (re)transmit the remaining TBs.

In some embodiments, in addition to the proposed UE actions on how to handle the HARQ process, the UE may also perform an additional action to set the NDI bits to zero for all HARQ processes (optionally, all non-idle HARQ processes) in a CG configuration when the UE receives a DCI deactivation command for the CG configuration.

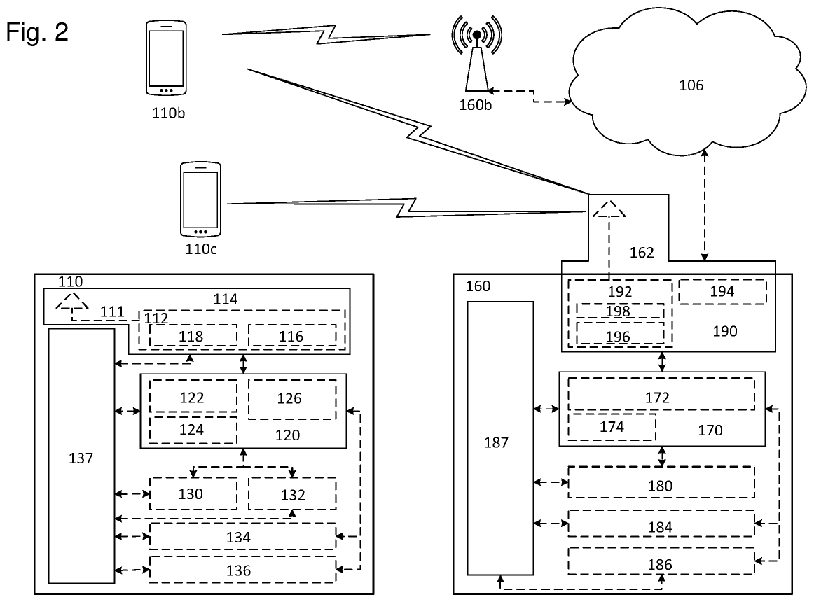

In FIG. 2, network node 160 includes processing circuitry 170, device readable medium 180, interface 190, auxiliary equipment 184, power source 186, power circuitry 187, and antenna 162. Although network node 160 illustrated in the example wireless network of FIG. 2 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 2 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

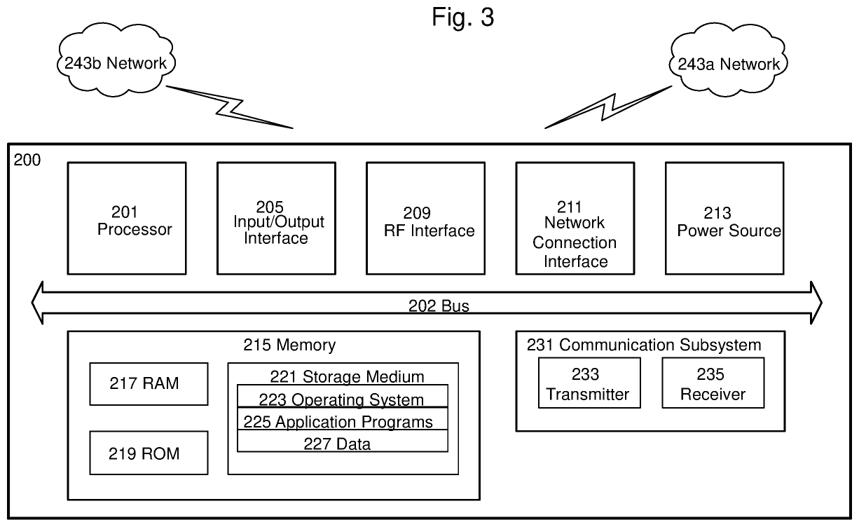

FIG. 3 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 3, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 3 is a UE, the components discussed herein are equally applicable to a WD, and vice-versa.

In FIG. 3, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 3, or only a subset of the components. The level of integration between the components may vary from one UE to another UE. Further, certain UEs may contain multiple instances of a component, such as multiple processors, memories, transceivers, transmitters, receivers, etc.

In FIG. 3, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 3, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 3, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

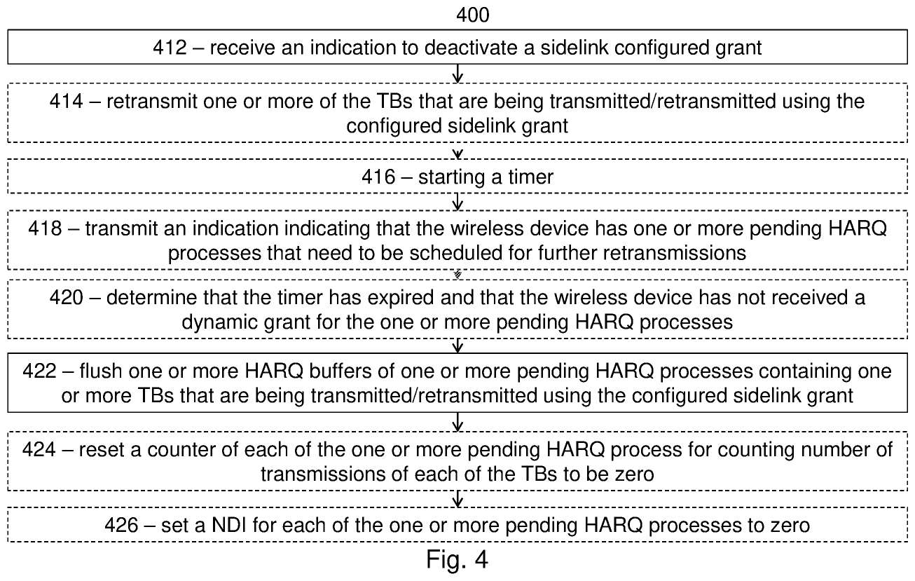

FIG. 4 is a flowchart illustrating an example method in a wireless device, according to certain embodiments. In particular embodiments, one or more steps of FIG. 4 may be performed by wireless device 110 described with respect to FIG. 2. The wireless device is operable to deactivate a sidelink configured grant.

The method begins at step 412, where the wireless device (e.g., wireless device 110) receives an indication to deactivate a sidelink configured grant. In response to the indication, the method may go directly to step 422 where the wireless device flushes one or more HARQ buffers of one or more pending HARQ processes containing one or more TBs that are being transmitted/retransmitted using the configured sidelink grant.

In some embodiments, prior to step 422 the wireless device may perform other optional steps. For example, at step 414, the wireless device retransmits one or more of the TBs that are being transmitted/retransmitted using the configured sidelink grant. The wireless device may automatically retransmit for a preconfigured number of retransmission attempts in anticipation that one of the transmissions will be successful.

In some embodiments, the wireless device transmits an indication indicating that the wireless device has one or more pending HARQ processes that need to be scheduled for further retransmissions at step 418.

The indication may include one or more of: a HARQ process index; a transport block size; an identifier of a logical channel; a service or traffic type associated with the one or more TBs; and a remaining packet delay budget for the one or more TBs.

In particular embodiments, the indication comprises a negative HARQ acknowledgment for each of the one or more pending HARQ processes or a scheduling request for each of the one or more pending HARQ processes.

In some embodiments, the indication is a notification to the network node and the network node determines what if any actions to take upon receiving the notification.

In some embodiments, the indication is a request for a scheduling grant for the pending HARQ processes. In such cases, the wireless device may start a timer at step 416. If the wireless device then receives the scheduling grant, the wireless device may use it to transmit the TBs in the pending HARQ processes. At step 420, if the timer has expired and the wireless device has not received a dynamic grant for the one or more pending HARQ processes, then the method continues to step 422 and flushes the one or more HARQ buffers.

Some embodiments include additional steps. For example, at step 424, the wireless device may reset a counter of each of the one or more pending HARQ process for counting number of transmissions of each of the TBs to be zero. At step 426, the wireless device may set a NDI for each of the one or more pending HARQ processes to zero.

Modifications, additions, or omissions may be made to method 400 of FIG. 4. Additionally, one or more steps in the method of FIG. 4 may be performed in parallel or in any suitable order. For example, the wireless device may start the timer before or after sending a request to the network node.

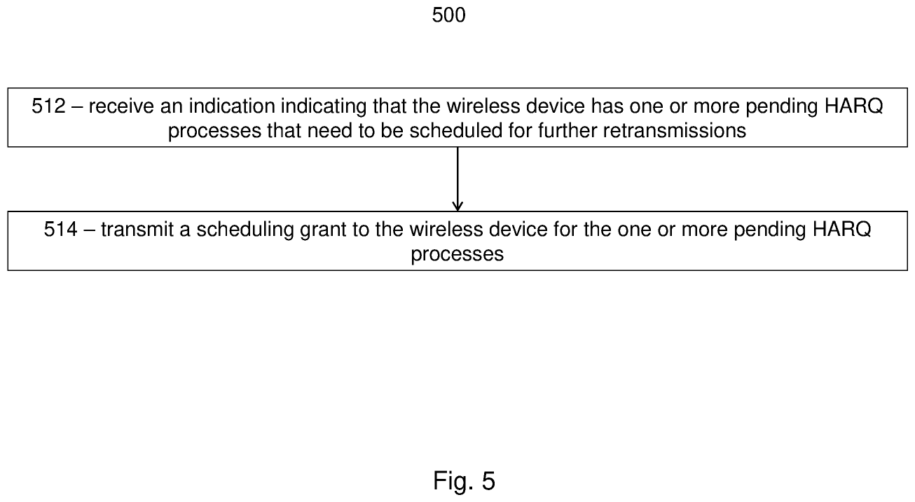

FIG. 5 is a flowchart illustrating an example method in a network node, according to certain embodiments. In particular embodiments, one or more steps of FIG. 5 may be performed by network node 160 described with respect to FIG. 2.

The method begins at step 512, where the network node (e.g., network node 160) receives an indication indicating that a wireless device has one or more pending HARQ processes that need to be scheduled for further retransmissions. For example, the wireless device may have deactivated a sidelink configured grant with pending HARQ processes. The wireless device may notify the network node so the network node can take corrective action. For example, the network node may continue to step 514.

At step 514, the network node transmits a scheduling grant to the wireless device for the one or more pending HARQ processes. The wireless device may use the grant to transmit the TBs in the one or more pending HARQ processes.

Modifications, additions, or omissions may be made to method 500 of FIG. 5. Additionally, one or more steps in the method of FIG. 5 may be performed in parallel or in any suitable order.

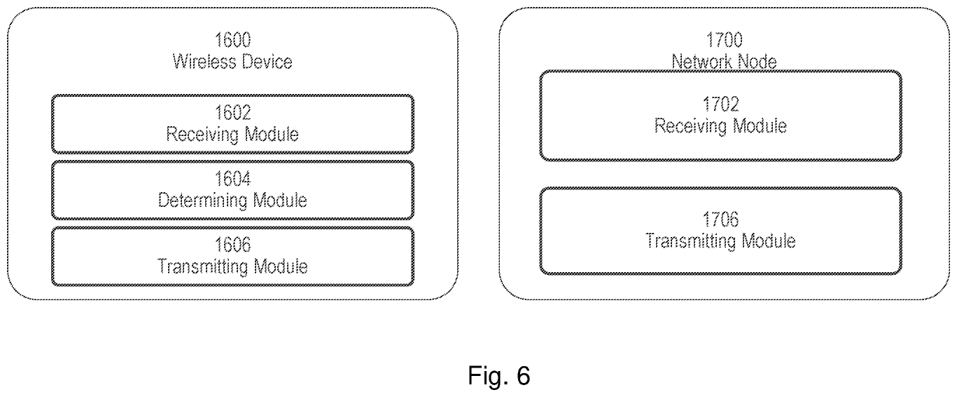

FIG. 6 illustrates a schematic block diagram of two apparatuses in a wireless network (for example, the wireless network illustrated in FIG. 2). The apparatuses include a wireless device and a network node (e.g., wireless device 110 and network node 160 illustrated in FIG. 2). Apparatuses 1600 and 1700 are operable to carry out the example methods described with reference to FIGS. 4 and 5, respectively, and possibly any other processes or methods disclosed herein. It is also to be understood that the methods of FIGS. 4 and 5 are not necessarily carried out solely by apparatuses 1600 and/or 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure. Similarly, the processing circuitry described above may be used to cause obtaining module 1702, transmitting module 1706, and any other suitable units of apparatus 1700 to perform corresponding functions according one or more embodiments of the present disclosure.

As illustrated in FIG. 6, apparatus 1600 includes receiving module 1602 configured to receive an indication to deactivate a sidelink configured grant and one or more scheduling grants according to any of the embodiments and examples described herein. Determining module 1604 is configured to determine whether the wireless device has received scheduling grants and whether a timer has expired according to any of the embodiments and examples described herein. Transmitting module 1606 is configured to transmit notifications and/or requests to a network node, according to any of the embodiments and examples described herein.

As illustrated in FIG. 6, apparatus 1700 includes receiving module 1702 configured to receive notifications or requests from a wireless device according to any of the embodiments and examples described herein. Transmitting module 1706 is configured to transmit an indication to deactivate a sidelink configured grant and transmit scheduling grants according to any of the embodiments and examples described herein.

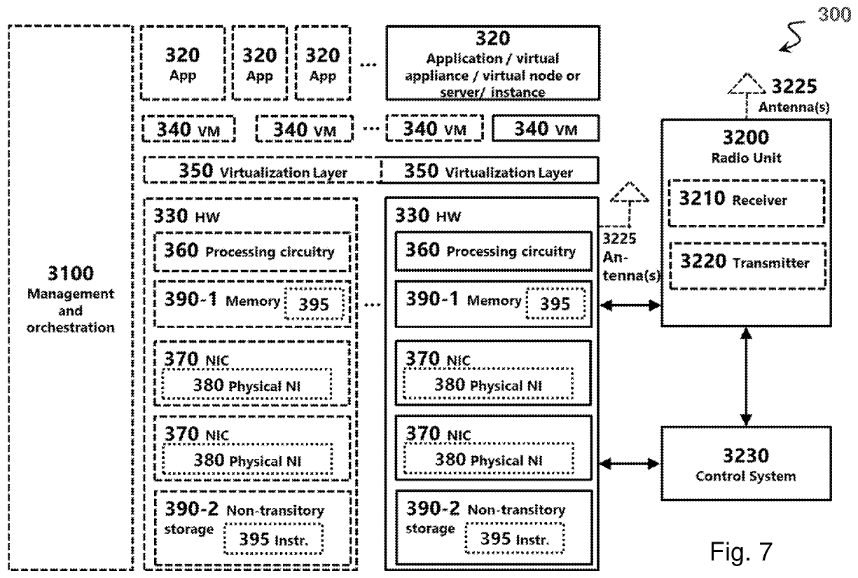

FIG. 7 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 7, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

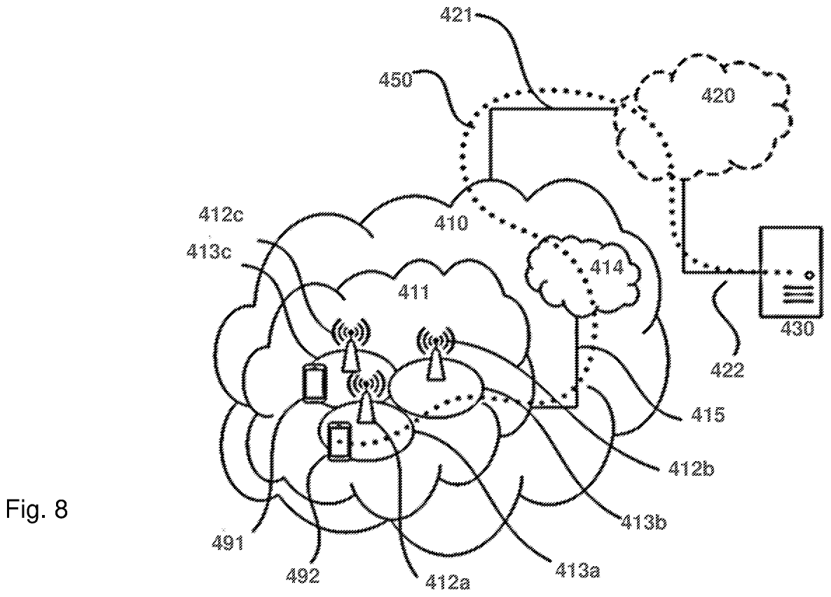

With reference to FIG. 8, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

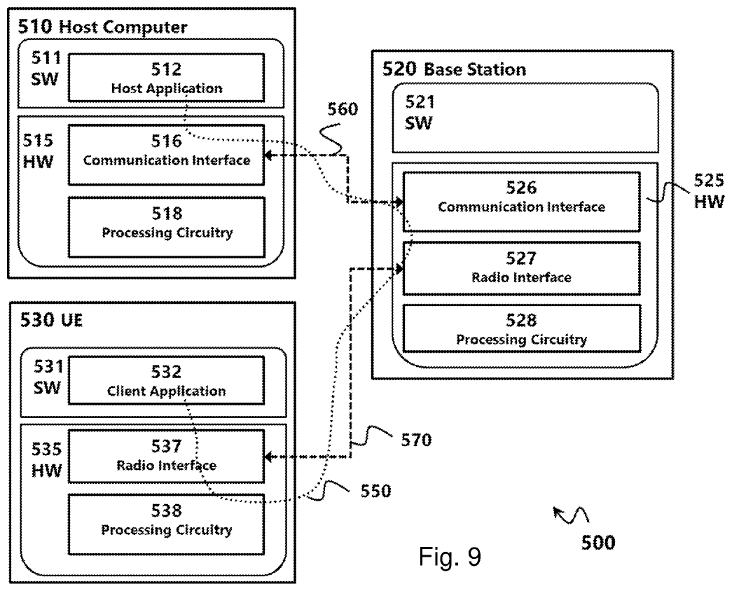

FIG. 9 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by base station 520. Communication interface 526 may be configured to facilitate connection 560 to host computer 510. Connection 560 may be direct, or it may pass through a core network (not shown in FIG. 9) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 9 may be similar or identical to host computer 430, one of base stations 412a, 412b, 412c and one of UEs 491, 492 of FIG. 7, respectively. This is to say, the inner workings of these entities may be as shown in FIG. 9 and independently, the surrounding network topology may be that of FIG. 7.

In FIG. 9, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

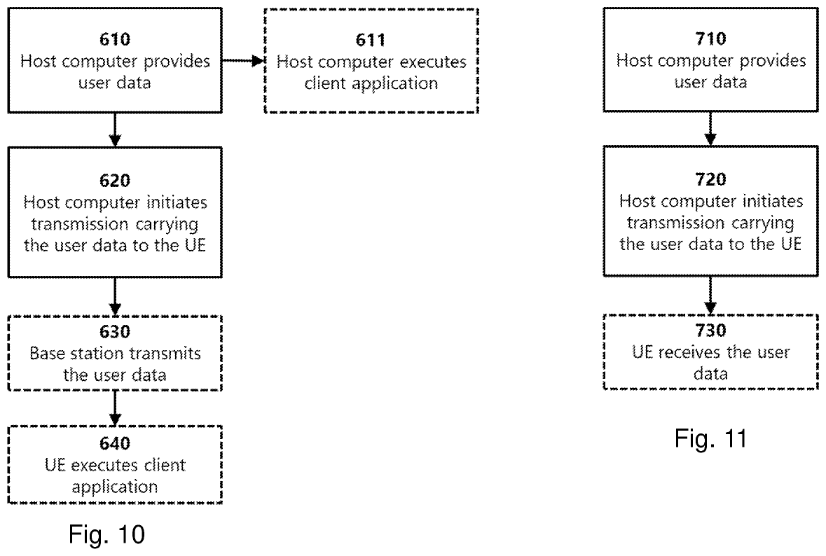

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

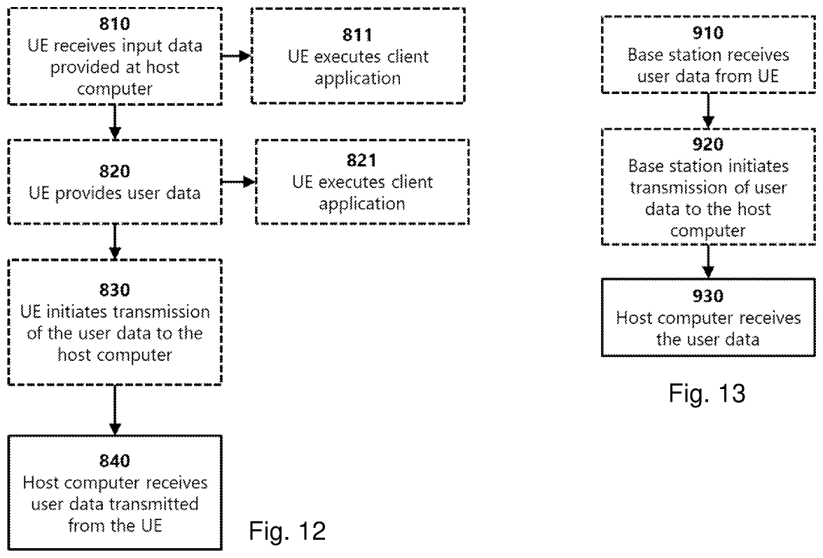

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device for deactivating a sidelink configured grant, the method comprising:
receiving an indication to deactivate a sidelink configured grant; and
flushing one or more hybrid automatic repeat request (HARQ) buffers of one or more pending HARQ processes containing one or more transport blocks (TBs) that are being transmitted/retransmitted using the configured sidelink grant.

2. The method of claim 1, further comprising:
prior to flushing the one or more HARQ buffers, retransmitting one or more of the TBs that are being transmitted/retransmitted using the configured sidelink grant.

3. The method of claim 1, further comprising:
transmitting an indication to a network node indicating that the wireless device has one or more pending HARQ processes that need to be scheduled for further retransmissions.

4. The method of claim 3, wherein the indication includes one or more of:
a HARQ process index;
a transport block size;
an identifier of a logical channel;
a service or traffic type associated with the one or more TBs; and
a remaining packet delay budget for the one or more TBs.

5. The method of claim 3, wherein the indication comprises a negative HARQ acknowledgment for each of the one or more pending HARQ processes.

6. The method of claim 3, wherein the indication comprises a scheduling request for each of the one or more pending HARQ processes.

7. The method of claim 3, further comprising:
starting a timer; and
prior to flushing the one or more HARQ buffers of the one or more pending HARQ processes, determining that the timer has expired and that the wireless device has not received a dynamic grant for the one or more pending HARQ processes.

8. The method of claim 3, wherein a duration of the timer is based on a remaining packet delay budget for the TBs that are being transmitted/retransmitted using the configured sidelink grant.

9. The method of claim 1, further comprising resetting a counter of each of the one or more pending HARQ process for counting number of transmissions of each of the TBs to be zero.

10. The method of claim 1, further comprising setting (426) a new data indicator (NDI) for each of the one or more pending HARQ processes to zero.

11. The method of claim 1, wherein the indication to deactivate a sidelink configured grant includes one or more HARQ process identifiers and flushing the one or pending HARQ processes comprises flushing the HARQ processes associated with the one or more HARQ process identifiers.

12. A wireless device operable to deactivate a sidelink configured grant, the wireless device comprising processing circuitry operable to:
receive an indication to deactivate a sidelink configured grant; and
flush one or more hybrid automatic repeat request (HARQ) buffers of one or more pending HARQ processes containing one or more transport blocks (TBs) that are being transmitted/retransmitted using the configured sidelink grant.

13. The wireless device of claim 12, the processing circuitry further operable to:
prior to flushing the one or more HARQ buffers, retransmit one or more of the TBs that are being transmitted/retransmitted using the configured sidelink grant.

14. The wireless device of claim 12, the processing circuitry further operable to:
transmit an indication to a network node indicating that the wireless device has one or more pending HARQ processes that need to be scheduled for further retransmissions.

15. The wireless device of claim 14, wherein the indication includes one or more of:
a HARQ process index;
a transport block size;
an identifier of a logical channel;
a service or traffic type associated with the one or more TBs; and
a remaining packet delay budget for the one or more TBs.

16. The wireless device of claim 14, wherein the indication comprises a negative HARQ acknowledgment for each of the one or more pending HARQ processes.

17. The wireless device of claim 14, wherein the indication comprises a scheduling request for each of the one or more pending HARQ processes.

18. The wireless device of claim 14, the processing circuitry further operable to:
start a timer; and
prior to flushing the one or more HARQ buffers of the one or more pending HARQ processes, determine that the timer has expired and that the wireless device has not received a dynamic grant for the one or more pending HARQ processes.

19. The wireless device of claim 14, wherein a duration of the timer is based on a remaining packet delay budget for the TBs that are being transmitted/retransmitted using the configured sidelink grant.

20. The wireless device of claim 12, the processing circuitry further operable to reset a counter of each of the one or more pending HARQ process for counting number of transmissions of each of the TBs to be zero.

21. The wireless device of claim 12, the processing circuitry further operable to set a new data indicator (NDI) for each of the one or more pending HARQ processes to zero.

22. The wireless device of claim 12, wherein the indication to deactivate a sidelink configured grant includes one or more HARQ process identifiers and flushing the one or pending HARQ processes comprises flushing the HARQ processes associated with the one or more HARQ process identifiers.
